(19) United States
(12) Patent Application Publication
(10) Pub. No.: US 2018/0038515 A1
(43) Pub. Date: Feb. 8, 2018

(54) METHOD AND APPARATUS FOR FLOODING A SUBSEA PIPELINE

(71) Applicant: BAKER HUGHES, A GE COMPANY, LLC, HOUSTON, TX (US)

(72) Inventor: PETER MARTIN DIXON, PEEBLES (GB)

(73) Assignee: BAKER HUGHES, A GE COMPANY, LLC, HOUSTON, TX (US)

(21) Appl. No.: 15/229,736

(22) Filed: Aug. 5, 2016

(51) Int. Cl. F16L 1/16; F04F 5/10; F16L 55/26; F04F 5/46; F16L 1/235; F16L 1/20

(52) U.S. Cl. CPC F16L 1/163; F16L 1/235; F16L 1/205; F16L 55/26; F04F 5/46; F04F 5/10

(57) ABSTRACT

A method and system for flooding a subsea pipeline includes a high pressure/low flow pump in fluid communication with a jet pump, which pumps a pig through the subsea pipeline.

### BACKGROUND OF THE INVENTION

### 1. Field of the Disclosure

This disclosure relates generally to the field of subsea pipelines for oil or gas, and in particular to the initial pre-commissioning of such subsea pipelines prior to their use to convey oil or gas.

### 2. Description of the Related Art

Offshore efforts to produce oil and gas typically require subsea pipelines for transport of oil and gas from wellheads to gathering structures, hub facilities and to onshore processing refineries. Newly constructed subsea pipelines must undergo a series of pre-commissioning steps which generally may include flooding, cleaning and gauging, hydrotesting, dewatering and drying before any oil or gas product can be introduced into the pipeline. The initial flooding operations typically include pushing, or pumping, a preinstalled pig, or pigs, through the pipeline with seawater, which may be chemically treated and filtered. The pipeline may be flooded between a pair of valved closures such as pipeline end terminations. The pig, or pigs, passing through the pipeline in conjunction with flooding may clean the pipeline of millscale and other debris, as well as assess dents, buckles and other out of round defects in the pipeline. Typically, an electric or hydraulic pump associated with or on a subsea vehicle, or Remote Operated Vehicle (“ROV”), is used to push, or pump, the pig in the initial flooding operations.

### BRIEF SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one illustrative embodiment, a system for flooding a subsea pipeline with seawater may include: a high pressure/low flow pump; a jet pump having a jet pump housing, a nozzle within the jet pump housing having a nozzle inlet in fluid communication with the high pressure/low flow pump and a nozzle outlet, a fluid inlet in the jet pump housing in fluid communication with the nozzle outlet, a diffuser in the jet pump housing in fluid communication with the nozzle outlet and the fluid inlet and a diffuser outlet adapted to be in fluid communication with the subsea pipeline.

In another illustrative embodiment, a method for flooding a subsea pipeline with seawater may include: disposing a high pressure/low flow pump in fluid communication with a nozzle inlet of a nozzle disposed within a jet pump housing of a jet pump; pumping sea water with the high pressure/low flow pump into the nozzle inlet of the jet pump and out of a nozzle outlet into the jet pump housing sucking in seawater into the jet pump housing through a fluid inlet in the jet pump housing; pumping the seawater from the nozzle outlet and the seawater from the fluid inlet through into a diffuser in the jet pump housing; and pumping seawater from the diffuser into the subsea pipeline.

In another illustrative embodiment, a subsea pipeline may include: at least one subsea pipe section disposed between first and second pipeline end terminations; a high pressure/low flow pump; a jet pump having a jet pump housing, a nozzle within the jet pump housing having a nozzle inlet in fluid communication with the high pressure/low flow pump and a nozzle outlet, a fluid inlet in the jet pump housing in fluid communication with the nozzle outlet, a diffuser in the jet pump housing in fluid communication with the nozzle outlet and the fluid inlet, and a diffuser outlet adapted to be in fluid communication with the first pipeline end termination of the at least one subsea pipe section; and at least one pig disposed in the at least one subsea pipe section.

### BRIEF DESCRIPTION OF THE DRAWING

The present system and method may be understood by reference to the following description taken in conjunction with the accompanying drawing, in which:

FIG. 1 is a side view of a subsea pipeline section and a vessel in accordance with an illustrative embodiment;

FIG. 2 is a side view of the pipeline section of FIG. 1 in more detail; and

FIG. 3 is an enlarged partial cross-sectional view of the pipeline section of FIG. 2 denoted by dotted-line circle 3 of FIG. 2.

While certain embodiments of the present system and method will be described in connection with the present illustrative embodiments shown herein, it will be understood that it is not intended to limit the invention to those embodiments. On the contrary, it is intended to cover all alternatives, modifications, and equivalents, as may be included within the spirit and scope of the invention as defined by the appended claims. In the drawing figures, which are not to scale, the same reference numerals are used throughout the description and in the drawing figures for components and elements having the same structure, and primed reference numerals may be used for components and elements having a similar function and construction to those components and elements having the same unprimed reference numerals.

### DETAILED DESCRIPTION OF THE SPECIFIC EMBODIMENTS

It should be understood that, although an illustrative implementation of one or more embodiments are provided below, the various specific embodiments may be implemented using any number of techniques known by persons of ordinary skill in the art. The disclosure should in no way be limited to the illustrative embodiments, drawings, and/or techniques illustrated below, including the exemplary designs and implementations illustrated and described herein. Furthermore, the disclosure may be modified within the scope of the appended claims along with their full scope of equivalents.

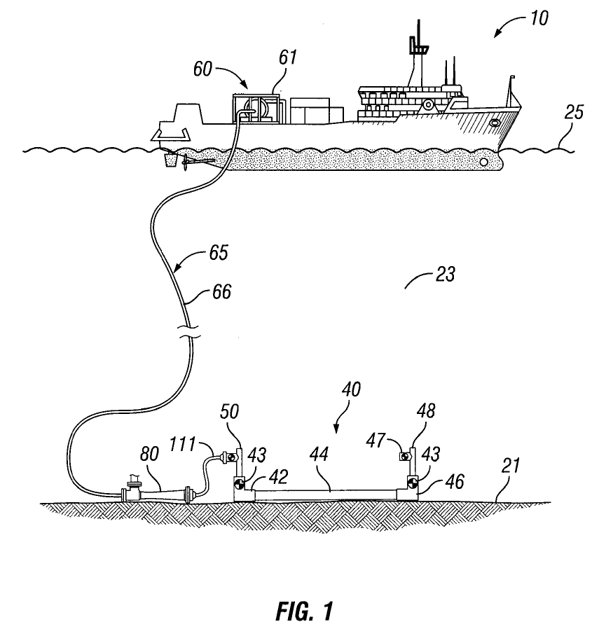

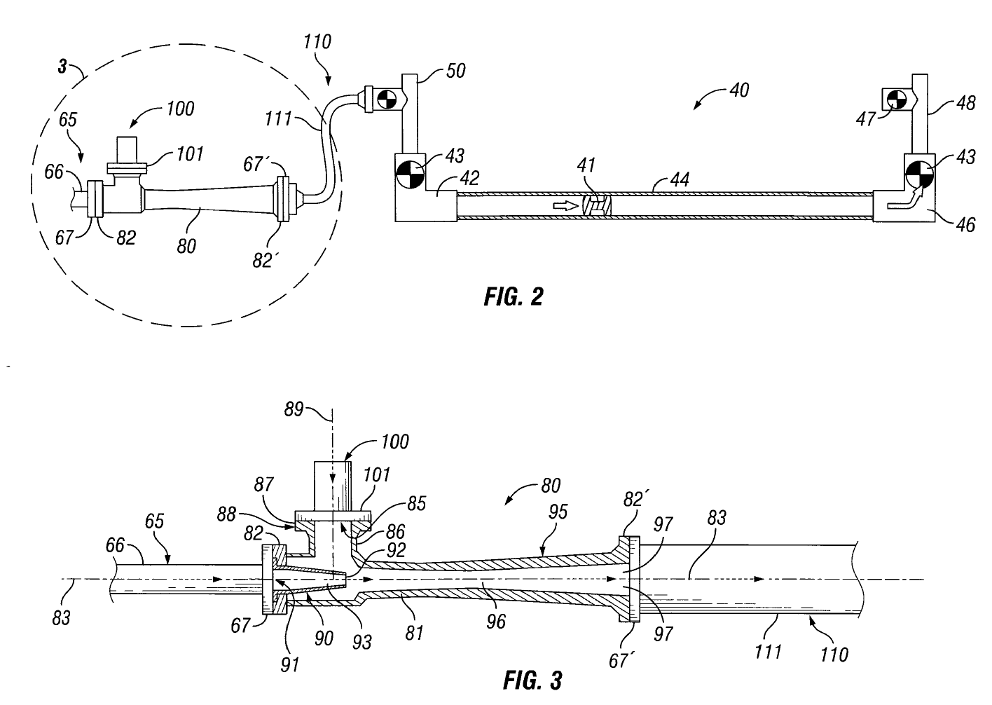

With reference to FIGS. 1 and 2, a subsea pipeline 40 on sea, or ocean, floor 21 has at least one pipe section 44 disposed between two pipeline end terminations 42, 46. The pipeline end termination 42, 46 can include any type of suitable valve closure 43 for a subsea pipeline and can include hot stab connections 47 or laydown heads for abandonment, recovery, or initiation. The pipeline end terminations 42, 46 can also include subsea collection hubs having several pipeline terminations and valved closures. Such hubs can be dimensioned to connect a number of flowlines carrying oil and gas from various subsea fields to production lines that may run to onshore facilitates. A support vessel, or ship, 10, or any other suitable platform for supporting operations for the subsea pipeline 40, is located above the pipeline 40.

To initially flood the pipeline 40, at least one pig 41 may be loaded into the pipeline 40 using any suitable technique. For example, the pig 41 may be launched from the support vessel 10 using available techniques and systems connecting to the pipeline 40. Alternatively, as shown in FIGS. 1 and 2, a pig launcher 50 may be associated with the pipeline end termination 42 for launching the at least one pig 40. A pig receiver manifold 48, may be associated with the other pipeline end termination 46 to receive the pig 41, after it has been pushed, or pumped through pipeline 40.

As seen in FIG. 1, support vessel, or ship, 10 on the ocean surface 25, is generally located above the pipeline 20. Ship 10 has at least one high pressure/low flow pump, or pumps, 60 associated with ship 10 in any suitable manner. High pressure/low flow pump 60 may be mounted upon the upper deck of ship 10 as shown in FIG. 1, or optionally, disposed below deck within ship 10. The high pressure/low flow pump 60 may be of any conventional design, having the requisite pressure and flow characteristics to operate in the manner to be hereinafter described.

Pump, or pumps, 60 may be a test pump 61 which are sometimes found on support ships or vessels, 10 in connection with offshore operations. Pump 60 is preferably capable of pumping a fluid, such as seawater, at a pressure range of from 50 to 690 bar, at a flow rate in the range of 6 to 120 M³/hr for each pump. Seawater to be pumped by pump 60 may be obtained from the sea 23 in any conventional manner, such as by use of a suction line (not shown) placed within the ocean 23 and in fluid communication between the ocean 23 and the inlet, or suction side, of pump 60. A downline 65 extends downwardly from pump 60 to a jet pump 80, as will hereinafter be described in greater detail. A downline is a conduit between a vessel, or ship, on the ocean surface and a subsea pipeline connection. Downline 65 may be coiled tubing or a hose, 66 of any suitable construction having the requisite strength characteristics to be used in an offshore environment to pump a fluid, such as seawater, at a high pressure and low flow rate from pump 60 to jet pump 80. Jet pump may be associated with, and rest upon, a subsea skid frame (not shown) which rests upon the ocean floor 21.

With reference to FIGS. 2 and 3, jet pump 80 will be described in greater detail. Jet pump 80 is sometimes also referred to as an ejector and eductor. Jet pump 80 preferably includes a jet pump housing 81, which houses the various components of jet pump 80. Jet pump housing 81 may be made of any suitable metal or plastic material capable of subsea use in seawater upon ocean floor 21. It must also have the requisite strength characteristics to withstand the forces exerted upon it by the seawater being pumped through it from the high pressure/low flow pump 60 and from the pressure forces exerted upon it by sea 23. Within housing 81 is disposed a nozzle 90 having a nozzle inlet 91 and a nozzle outlet 92. Nozzle 90 is in fluid communication with the high pressure/low flow pump 60 from its connection to the downline 65. Housing 81 may include an annular flange 82 against which a mating flange 67 associated with the bottom end of downline 65 may be secured. Any other suitable connection between the downline 65 and pump housing 81 may be utilized such as a hose attached to downline 65, which hose may then be stabbed into pump housing 81.

Housing 81 also includes a fluid inlet 85 which may be an annular pipe section 86, which includes an annular flange 87 at its upper end 88. The jet pump housing 81 includes a diffuser 95 which has a diffuser inlet 96 and a diffused outlet 97 as shown in FIG. 3. Jet pump housing 81, nozzle 90, and diffuser 95 each have a longitudinal axis, and preferably, each longitudinal axis of jet pump housing 81, nozzle 90, and diffuser 95 coincide with each other, as shown at 83 in FIG. 3. Preferably, the fluid inlet 85, or annular pipe section 86 has a longitudinal axis 88 which is preferably disposed substantially perpendicular to the longitudinal axis 83 of the jet pump housing 81, nozzle 90, and diffuser 95.

The nozzle inlet 91 of nozzle 90 is in fluid communication with the high pressure/low flow pump 60 via downline 65 and the fluid, or seawater, being pumped by the pump 60 enters the nozzle inlet 91 and exits nozzle outlet 92. The fluid being pumped through downline 65 would have a flow rate and pressure commensurate with the water depth, pipeline diameter, and the desired speed for the pig 41 in pipeline 40. As an example, the flow rate may be approximately 45 M³/hr and at a pressure of approximately 400 bar. Nozzle 90 is a tapering tube 93 having a circular cross-sectional configuration, whereby the diameter of tube 93 at the nozzle inlet 91 decreases as tube 93 tapers to nozzle outlet 92. As the fluid, or seawater, being pumped by pump 60 enters nozzle inlet 91, the high pressure seawater which initially enters nozzle outlet 91 at a low flow rate is compressed as it passes through nozzle 90 toward nozzle outlet 92. The seawater exiting the nozzle outlet 92 is then moving at a much higher velocity, or speed, but is at a much lower pressure. The increase in the velocity of the seawater fluid exiting nozzle 90 and the lowering of the pressure of the seawater exiting fluid outlet 92 results from the Bernoulli's Principle.

As seen in FIG. 3, fluid inlet 85 in the jet pump housing 81 is in fluid communication with the nozzle outlet 92. The seawater exiting nozzle outlet 92 is at a lower pressure and creates a suction force which sucks seawater into the fluid inlet 85 from the ocean 23. As an example, the seawater being sucked into the fluid inlet 85 may be at a pressure of approximately 200 bar at a flow rate of approximately 156 M³/hr. The seawater from the nozzle outlet 92 and the seawater being sucked into the jet pump housing 81 through the fluid inlet 85, then passes through, or is pumped through, jet pump housing 81 into the diffuser 95. The diffuser 95 in jet pump housing 81 has a diffuser inlet 96 and a diffuser outlet 97. The diffuser 95 has a generally tapering tubular shape with a circular cross-sectional configuration and the diameter of the diffuser 95 increases from the diffuser inlet 96 to a larger diameter at the diffuser outlet 97. The seawater as it flows, or is pumped, through the diffuser 95 from the diffuser inlet 96 to the diffuser outlet 97 flows at a slower velocity at a high flow rate, while at the same time, its pressure is increased as it exits from the diffuser outlet 97 and into pipeline 40. The pressure of the seawater exiting the diffuser outlet 97 is at an intermediate pressure level, which is less than the high pressure of the seawater initially entering nozzle 90 and higher than the pressure of the seawater entering pump 80 through fluid inlet 85.

The seawater exiting the diffuser outlet may have a flow rate in the range of from 100 M³/hr to 1000 M³/hr and a pressure in the range of from 1 bar to 40 bar above the subsea pressure where pipeline 40 is located. As an example, the flow rate may be approximately 200 M³/hr at a pressure of approximately 214 bar.

Preferably, and optionally, the fluid inlet 85 may be provided with a filter 100 which has an annular flange fitting 101 which permits filter 100 to be connected to the annular flange 87 of fluid inlet 85. Thus, as seawater is sucked into fluid inlet 85, it first passes through filter 100 which filters, or screens, undesired materials, such as seaweed, and other similar undesired materials, from entering jet pump 80.

With reference to FIGS. 2 and 3, jet pump housing 81 may have an annular flange member 82′ adjacent the diffuser outlet 97, and annular flange member 82′ of jet pump housing 81 may be secured to a mating annular flange member 67′ associated with a pump discharge conduit 110 which is in fluid communication with pump 80 and the pipe end termination 42 via the pig launcher 50. Seawater exiting diffuser outlet 97 of the jet pump 80 may then pass into the pipe end termination 42 via the pig launcher 50 and into pipe section 44 of pipeline 40 to pump, or push, pig 41 within pipe section 44 from the first pipeline end termination 42 toward the second pipeline end termination 46, as shown in FIG. 2. The diffuser outlet 97 of jet pump 80 could be connected to the pig launcher 50 by use of a pump discharge hose 111, or other tubular structure (not shown), in fluid communication with pig launcher 50 and pump 80. The pump discharge hose 111 may be connected to the diffuser outlet by any suitable connection, such as the flanged connection shown in FIG. 3 or by a stab connection (not shown). Similarly the pump discharge hose 111 may be connected to the pig launcher by any suitable connection such as a flange connection or a stab connection. Alternatively, and optionally, the diffuser outlet 97 of jet pump 80 could be connected directly to the first pipeline end termination by a pump discharge hose (not shown) in fluid communication with the first pipeline end termination 42 and the pump 80.

Although pump 80 resting upon a subsea skid frame on the ocean floor 21 adjacent subsea pipeline 40 is described in connection with FIG. 1, pump 80, optionally and alternatively, could be disposed on a subsea skid frame (not shown) hanging from the downline 65 above the ocean floor 21. The pump discharge hose 111 attached to pump 80 would then be connected to the first pipeline end termination 42 via pig launcher 50, or a pump discharge hose (not shown) like pump discharge hose 111 could be connected directly to the first pipeline end termination 42. Alternatively and optionally, the downline 65 could be connected to a flow line (not shown) associated with, or attached to the subsea skid frame, and the pump discharge hose 111 could be attached to the flow line of the subsea skid frame at one end of the pump discharge hose 111 and the other end of the pump discharge hose 111 could then be attached to the pig launcher 50.

If desired, the seawater being pumped by the high pressure/low flow pump 60 of vessel 10 could be chemically treated before it is pumped to jet pump 80 via downline 65 to add at least one chemical to the seawater pumped from pump 60 and ultimately into the pipe section 44 of subsea pipeline 40. If desired, seawater exiting diffuser 95 may pass through a flowmeter and/or by a pressure transducer to provide the operator of the jet pump 80 with information as to the operation of the jet pump 80.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. When numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means ±10% of the subsequent number, unless otherwise stated.

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above, but is defined by the claims that follow, that scope including all equivalents of the subject matter of the claims. Each and every claim is incorporated as further disclosure into the specification and the claims are embodiment(s) of the present disclosure.

While several embodiments have been provided in the present disclosure, it may be understood that the disclosed embodiments might be embodied in many other specific forms without departing from the spirit or scope of the present disclosure and the appended claims. The present examples are to be considered as illustrative and not restrictive, and the intention is not to be limited to the details given herein. For example, the various elements or components may be combined or integrated in another system or certain features may be omitted, or not implemented.

In addition, the various embodiments described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

1. A system for flooding a subsea pipeline with seawater, comprising:
a high pressure and low flow pump;
a jet pump having a jet pump housing, a nozzle within the jet pump housing having a nozzle inlet in fluid communication with the high pressure and low flow pump and a nozzle outlet, a fluid inlet in the jet pump housing in fluid communication with the nozzle outlet, a diffuser in the jet pump housing in fluid communication with the nozzle outlet and the fluid inlet and a diffuser outlet in fluid communication with the interior of the subsea pipeline, whereby the subsea pipeline may be flooded with seawater.

2. The system of claim 1, wherein the subsea pipeline is located on an ocean floor beneath a body of water, and the high pressure and low flow pump is on a vessel located above the body of water.

3. The system of claim 2, wherein a downline extends from the high pressure and low flow pump to the nozzle inlet,

4. The system of claim 1, wherein a filter is associated with the fluid inlet in the jet pump housing, whereby seawater flowing into the pump housing through the filter is filtered by the filter.

5. A method for flooding a subsea pipeline with seawater, comprising:
disposing a high pressure and low flow pump in fluid communication with a nozzle inlet of a nozzle disposed within a jet pump housing of a jet pump;
pumping seawater with the high pressure and low flow pump into the nozzle inlet of the jet pump and out of a nozzle outlet into the jet pump housing;
sucking in seawater into the jet pump housing through a fluid inlet in the jet pump housing;
pumping the seawater from the nozzle outlet and the seawater from the fluid inlet into a diffuser in the jet pump housing; and
pumping seawater from the diffuser into the subsea pipeline.

6. The method of claim 5, including disposing the high pressure and low flow pump on a vessel located above a body of water wherein the subsea pipeline is located on an ocean floor, and utilizing a downline extending from the high pressure and low flow pump to the nozzle inlet of the nozzle within the jet pump housing to dispose the high pressure and low flow pump and the nozzle inlet in fluid communication.

7. The method of claim 5, including adding at least one chemical to the seawater being pumped by the high pressure and low flow pump into the nozzle inlet.

8. The method of claim 5, including filtering the seawater that is sucked into the jet pump housing through the fluid inlet.

9. The method of claim 5, including pumping at least one pig through a section of the subsea pipeline with the seawater from the diffuser.

10. A subsea pipeline, comprising:
at least one subsea pipe section disposed between first and second pipeline end terminations;
a high pressure and low flow pump;
a jet pump having a jet pump housing, a nozzle within the jet pump housing having a nozzle inlet in fluid communication with the high pressure and low flow pump and a nozzle outlet, a fluid inlet in the jet pump housing in fluid communication with the nozzle outlet, a diffuser in the jet pump housing in fluid communication with the nozzle outlet and the fluid inlet and a diffuser outlet in fluid communication with the first pipeline end termination of the at least one subsea pipe section; and
at least one pig disposed in the at least one subsea pipe section.

11. The subsea pipeline of claim 10, wherein the subsea pipeline is located on an ocean floor beneath a body of water, and the high pressure and low flow pump is on a vessel located above the body of water.

12. The subsea pipeline of claim 10, wherein a downline extends from the high pressure and low flow pump to the nozzle inlet.

13. The subsea pipeline of claim 10, wherein a filter is associated with the fluid inlet in the jet pump housing, whereby seawater flowing into the pump housing through the filter is filtered by the filter.
